(19) United States
(12) Patent Application Publication
(10) Pub. No.: US 2011/0098932 A1
(43) Pub. Date: Apr. 28, 2011

(54) METHOD AND APPARATUS FOR DETECTING PEDESTRIANS

(75) Inventor: Dror Lapidot, Ganei Hadar (IL)

(73) Assignee: ELTA SYSTEMS LTD., Ashdod (IL)

(21) Appl. No.: 12/672,834

(22) PCT Filed: Aug. 7, 2008
(86) PCT No.: PCT/IL2008/001096

§ 371 Date: Nov. 19, 2010

(30) Foreign Application Priority Data
Aug. 9, 2007 (IL) 185184

(51) Int. Cl. G06F 19/00; G01V 1/28

(52) U.S. Cl. 702/14; 702/56

(57) ABSTRACT

Detection of at least one object causing a signal of interest. In one embodiment, a method of detecting at least one object causing a persistent non-random pressure wave comprises: providing a digital signal representation of the pressure wave that includes respective amplitudes of the signal, in at least two different frequencies, and providing a detection indication based on a measured similarity between the respective amplitudes over time.

### FIELD OF THE INVENTION

This invention relates to object detection and specifically to detection of pedestrians.

### BACKGROUND OF THE INVENTION

Pedestrian detection is required for various applications, such as intrusion detection, security applications, area monitoring, automatic activation of systems in response to presence of persons, and the like. Pedestrian detection can be performed by manned and unmanned devices, in a fully or partially automated manner. For various military and civilian needs, pedestrian detection is performed by the use of ground sensors, including Unattended Ground Sensors (UGS), which are deployed within an area of interest.

Unattended Ground Sensors (UGS) facilitate the detection and classification of pedestrians (as well as of other objects, e.g. vehicles) by utilizing sensors such as acoustic, seismic, magnetic or Infra-Red (IR) sensors to monitor the environment. UGS devices are used for diverse tasks such as perimeter defense, wildlife protection and situation awareness. Since UGS devices often operate in remote or even hostile environments, they are usually self-supporting devices powered by autonomous power units and equipped with the ability to report detection to a remote station by transmitting a detection signal. Economic power consumption is crucial since the device is then operable for a longer time before power unit is shut-down or replacement is required. In addition, miniaturization is also preferable, as miniature UGS devices are easy to deploy.

U.S. Pat. No. 5,047,995 discloses a detector system having a channel for comparing the peak amplitude of at least one of two electrical signals, produced at the output of two spaced geophones, against an amplitude threshold, to produce an indication of a moving object when this threshold is exceeded. To reduce the number of false indications, the system includes a parallel channel for measuring the phase difference between the two signals, and a processing circuit responsive to both channels, to ensure that indication is allowed only when the measured phase difference changes sense. The parallel channel includes four flip-flops each to measure the phase difference and the outputs of these flip-flops are added together, to produce a phase dependent signal for controlling the processing circuit. Further discrimination is provided by timing the phase transition, a time gate being used to inhibit indication when the phase transition does not occur within prescribed time limits. The processing circuit also includes a memory circuit for comparing successive phase transitions. This memory circuit resolves transitions following in close succession and inhibits when intermediate phase transition of opposite sense occur, thus allowing resolution of close moving objects. The sense of the phase transition is used for indication of direction of transit.

U.S. Pat. No. 6,389,377 discloses a method and apparatus for using current-mode analog circuits using massively parallel computation to compute the correlation between an auditory input signal in the time-frequency domain and a stored binary template.

U.S. Pat. No. 7,020,701 discloses Wireless Integrated Network Sensor Next Generation (WINS NG) nodes that provide distributed network and Internet access to sensors, controls, and processors that are deeply embedded in equipment, facilities, and the environment. The WINS NG network allows for monitoring and control capability for applications in transportation, manufacturing, health care, environmental monitoring, and safety and security. The WINS NG nodes combine microsensor technology, low power distributed signal processing, low power computation, and low power, low cost wireless and/or wired networking capability in a compact system. The WINS NG networks provide sensing, local control, remote reconfigurability, and embedded intelligent systems in structures, materials, and environments.

Also relating to object detection and/or UGS systems and methods are the following patents and patent applications: U.S. Pat. Nos. 3,686,658; 3,696,369; 3,745,552; 3,879,720; 3,913,085; 4,110,730; 4,223,304; 4,521,768; 5,194,848; 5,483,222; 5,493,273; 6,288,395; 6,928,030; 7,079,986; US Patent Application No. 2002/0067661 and WO93/23973.

One of the challenges faced by the designers of pedestrian detection systems is the ability to reduce False Alarm Rate (FAR) and increase Probability of Detection (PD). Low Probability of Detection may result in critical events passing unnoticed. High False Alarm Rate may trigger a lot of unnecessary responses which quite often have the operators of any alarm system eventually shut down the system (when the alarm system is shutdown, PD=0). Additionally, high FAR increases power consumption owing to the extra energy used to transmit the detection signal to a remote station. Therefore, methods are known in the art aimed at processing the sensed signal in the sensor (e.g. UGS or other sensing device) itself in order to accurately identify true signals, resulting from objects of interest (such as signals resulting from pedestrians walking in the vicinity of the sensor), while ignoring non-relevant signals, such as background noise or random noise. Despite the fact that more sophisticated processing methods may lead to lower FAR and higher PD and detection range, they pose a problem since the increase in computation complexity increases UGS power consumption.

Typically, the intensity of seismic or acoustic signals produced by a pedestrian is lower than that produced by other objects such as land vehicles. Therefore, more sensitive seismic and acoustic sensors are required for pedestrian detection. This in turn, increases system requirements and budget. Furthermore, typically more sensors are required for pedestrian detection than the number required for monitoring vehicle presence over the same area to be monitored. Thus, increased detection range for each sensor is also desirable for pedestrian detection in order to achieve high detection range with fewer sensors.

There is therefore a need in the art for efficient detection of pedestrians which involves efficient computation in the processing of seismic and acoustic signals. There is a need in the art for efficient pedestrian detection systems and methods that provide increased detection range with fewer sensors. There is also a need in the art for an improved device capable of carrying out an improved processing method. There is still further a need in the art for a small scale device which is efficient, power-saving and long-lasting, and which provides high probability of detection, high detection range and low false alarm rates.

### SUMMARY OF THE INVENTION

According to an embodiment of the invention there is provided a method for detecting at least one object causing a persistent non-random pressure wave, the method comprising:

(i) providing a digital signal representation of the pressure wave that includes respective amplitudes of the signal, in at least two different frequencies; and
(ii) providing a detection indication based on a measured similarity between the respective amplitudes over time.

According to another embodiment of the invention there is provided a computerized method for analyzing a sensed signal in order to detect at least one object causing a persistent non-random signal of interest in a range of frequencies f, the method comprising:

(i) calculating a correlation function between at least two from among two or more intensity vectors, wherein each intensity vector is an amplitude representation in a certain time window of L seconds, of a digital signal indicative of the sensed signal at a distinct frequency belonging to the range of frequencies f; and
(ii) repeating the calculating with respect to different time windows and in case a predetermined correlation rule is met by the correlation function at least during a predefined duration of time t, indicating a detection of the object.

According to yet another embodiment of the invention there is provided a detection device for detecting at least one object causing a signal of interest, the device comprising a sensor for collecting a sensed signal; an A/D converter for converting the sensed signal to digital signal; a memory; a processor; and a computer module, the computer module comprising:
an input component for receiving digital signal indicative of the sensed signal, and for constituting at least two intensity vectors, wherein each intensity vector being an amplitude representation of the digital signal in a time domain, and wherein each intensity vector is associated with a distinct frequency falling in a range of frequencies f, and having a length of L seconds;
a calculation component for calculating a correlation function between the at least two intensity vectors, and
an indication component for indicating a detection of the signal of interest in case a predetermined correlation rule is met by the correlation function at least during a predefined duration of time t.

According to another embodiment of the invention there is provided a computer system for analyzing a sensed signal in order to detect at least one object causing a signal of interest, the system comprising an input/output utility, a memory, a processor, and a computer module, the computer module comprising:
an input component for receiving via the input/output utility, digital signal indicative of the sensed signal, and for constituting at least two intensity vectors, wherein each intensity vector being indicative of an amplitude representation of the digital signal in a time domain, and wherein each intensity vector is associated with a distinct frequency falling in a range of frequencies fand having a length of L seconds;
a calculation component for calculating a correlation function between the at least two from among two or more intensity vectors, and
an indication component for indicating via the input/output utility, a detection of the signal of interest in case a predetermined correlation rule is met by the correlation function at least during a predefined duration of time t.

According to another embodiment of the invention there is provided a computer module for analyzing a sensed signal in order to detect at least one object causing a signal of interest, the computer module comprising:
an input component for receiving digital signal indicative of the sensed signal, and for constituting at least two from among two or more intensity vectors, wherein each intensity vector being an amplitude representation of the digital signal in a time domain, and wherein each intensity vector is associated with a distinct frequency falling in a range of frequencies f and having a length of L seconds;
a calculation component for calculating a correlation function between the at least two from among two or more intensity vectors, and
an indication component for indicating a detection of the signal of interest in case a predetermined correlation rule is met by the correlation function at least during a predefined duration of time t.

According to another embodiment of the invention there is provided a program storage device readable by machine, tangibly embodying a program of instructions executable by the machine to perform a method for analyzing a sensed signal in order to detect at least one object causing a signal of interest, the method comprising:

(i) calculating a correlation function between at least two from among two or more intensity vectors, wherein each intensity vector being an amplitude representation in a time domain of a digital signal corresponding to the sensed signal, and wherein each intensity vector is associated with a distinct frequency belonging to a range of frequencies f and having a length of L seconds; and
(ii) in case a predetermined correlation rule is met by the correlation function at least during a predefined duration of time 1, indicating a detection of the signal of interest.

According to another embodiment of the invention there is provided a computer program product comprising a computer useable medium having computer readable program code embodied therein for analyzing a sensed signal in order to detect at least one object causing a signal of interest, the computer program product comprising:

computer readable program code for causing the computer to calculate a correlation function between at least two from among two or more intensity vectors, wherein each intensity vector being an amplitude representation in a time domain of a digital signal corresponding to the sensed signal, and wherein each intensity vector is associated with a distinct frequency belonging to a range of frequencies f and having a length of L seconds; and
computer readable program code for causing the computer, in case a predetermined correlation rule is met by the correlation function at least during a predefined duration of time t, to indicate a detection of the signal of interest.

According to another embodiment of the invention there is provided a method for detecting at least one object causing a seismic or an acoustic signal of interest having an ordered form, the method comprising

(i) sampling the seismic or acoustic signal at a sampling rate that facilitates collecting a sensed signal in a range of frequencies f and converting the sensed signal to digital signal;
(ii) calculating a correlation function between at least two from among two or more intensity vectors, wherein each intensity vector is an amplitude representation in a time domain of the digital signal, and wherein each intensity vector is associated with a distinct frequency belonging to the range of frequencies f and is having a length of L seconds; and
(iii) determining whether a predetermined correlation rule is met by the correlation function in order to indicate detection of the object.

### BRIEF DESCRIPTION OF THE DRAWINGS

In order to understand the invention and to see how it may be carried out in practice, some embodiments of the invention will now be described, by way of non-limiting example only, with reference to the accompanying drawings, in which:

FIG. 1 is a block diagram schematically illustrating an apparatus according to an embodiment of the invention;

FIG. 2 is a flowchart showing a sequence of operations carried out by an apparatus according to an embodiment of the invention;

FIG. 3 is another flowchart showing a sequence of operations carried out by an apparatus according to an embodiment of the invention;

FIGS. 4a-4d are graphical representations illustrating some of the operations carried out by an apparatus according to an embodiment of the invention;

FIG. 5 is a flowchart showing a sequence of operations carried out by an apparatus according to an embodiment of the invention;

FIGS. 6a-6b are graphical representations illustrating some of the operations carried out by an apparatus according to an embodiment of the invention;

FIG. 7 is a block diagram of a computer module according to an embodiment of the invention;

FIG. 8 is a block diagram schematically illustrating an apparatus according to an embodiment of the invention; and

FIG. 9 is a flowchart showing a sequence of operations carried out by an apparatus according to an embodiment of the invention.

### DETAILED DESCRIPTION OF EMBODIMENTS

The present invention provides systems and methods for detecting non-random persistent signals of interest. In the following, the principles of the present invention will be mainly described with respect to detection of non-random persistent pressure waves. There will be described an embodiment of the invention implementing a seismic sensor (other sensors e.g. acoustic sensors could be used for various applications) integrated with a computer system. A non-limiting example of such a detecting device is a UGS (Unattended Ground Sensor). There will be described a UGS that carries out all detection operations in a completely autonomous manner, in real-time, and which notifies a remote station with a detection signal, when required. This embodiment is denoted hereinafter as ‘autonomous UGS’. It should be understood that the invention is not limited to the ‘autonomous UGS’ embodiment and many other embodiments are possible, including, but not limited to, various allocations of operations between one or more UGS devices and other types of remote units. The present application is further not limited to a UGS device. According to another embodiment of the invention, there is provided a computerized system for analyzing a signal collected e.g. by a seismic sensor, in real time or off-line.

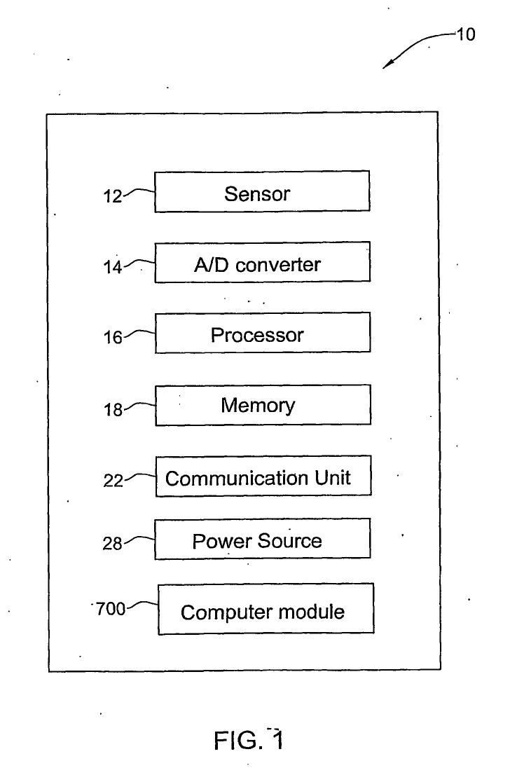

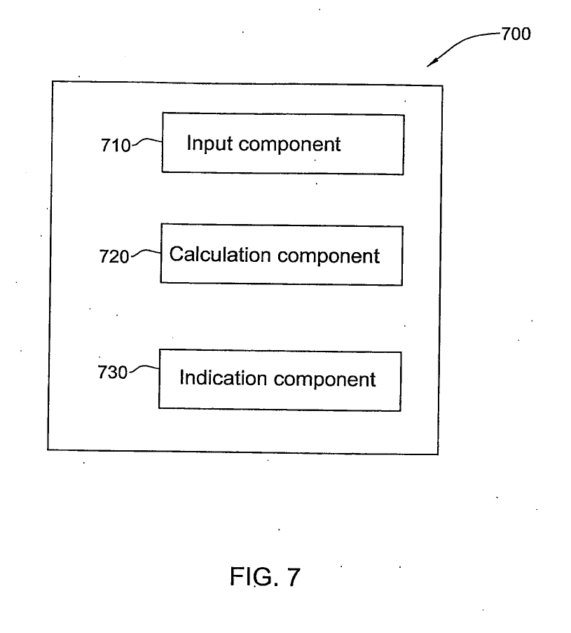

FIG. 1 is a block diagram schematically illustrating a UGS 10 according to an embodiment of the present invention ('autonomous UGS'). Unit 10 includes, inter-alia, at least one sensor or seismic sensor (e.g. geophone, accelerometer) 12 for collecting seismic signals; at least one Analog to Digital (A/D) converter 14 for converting the sensed seismic analog signal to a digital signal; a processing unit (processor) 16, and a computer module (such as computer module 700 illustrated in FIG. 7 and discussed further below) for processing the digital signal and for detecting an object (e.g. a pedestrian) causing a seismic signal in the vicinity of the UGS. Processor 16 functions as a controller controlling the operation of the sensor 12 and A/D converter 14. In one embodiment, computer module 700 comprises a computer program. In this embodiment, processor 16 is also configured to process the digital signal by executing this computer program which is stored in memory 18 and the processor is further configured to detect an object (e.g. a pedestrian) causing a seismic signal in the vicinity of the UGS by executing this computer program. Optionally, UGS 10 further comprises a communication unit 22 (e.g. a transmitter and an antenna) operable by the processor 16 to notify a remote station in case of detection. All elements 12-22 are powered by a local power source 28 (e.g. a battery, solar cell, etc.). According to certain embodiments of the present invention, all electronic elements are implemented as a single electronic module (e.g. printed circuit board).

According to an embodiment of the invention, unit 10 further comprises some other co-located sensors (e.g. seismic sensor, acoustic sensor, magnetic sensor, IR (Infra-Red) sensor—not shown in FIG. 1) which may be operated in parallel or in combination with some or all of the elements of unit 10 shown in FIG. 1. In order to clarify explanations, FIG. 1 illustrates only those elements required to present the principles of the present invention. It should be understood that the present invention is not limited by the illustrated configuration. Thus, according to an embodiment of the invention, the detection unit (e.g. UGS) includes several sensors, such as an acoustic sensor, a seismic sensor and even another sensor (e.g. magnetic sensor), coupled to a common processor using a common on-chip memory and fed by a common battery, utilizing one or more analysis methods for detecting e.g. pedestrians as well as other objects (vehicles for example).

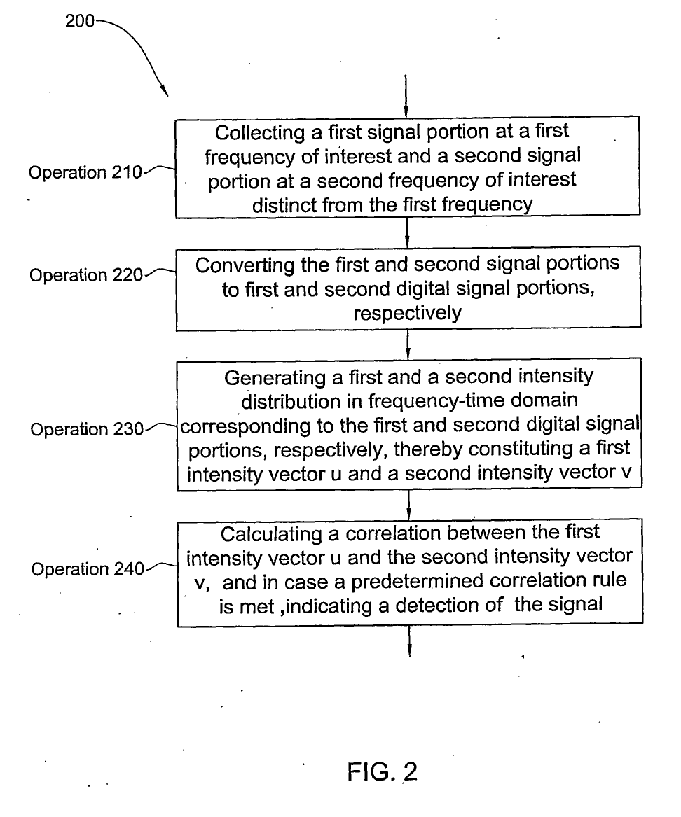

According to one embodiment of the invention, communication unit 22 includes a transmitter and an antenna capable of communicating with a remote monitoring station, relay units (e.g. transceivers in the vicinity of the UGS) and more. According to another embodiment of the invention, communication unit 22 includes a transceiver and antenna, thereby allowing the UGS 10 to e.g. receive commands from a remote station or to engage with other UGS in networked operating mode. According to yet another embodiment of the present invention, unit 10 further comprises a dedicated unit (not shown in FIG. 1) also operable by processor 16 to perform dedicated tasks in response to detection, e.g. in addition to or instead of communication unit 22. According to certain embodiments, the present invention provides a correlation-based detection algorithm and detection device. This will now be explained with respect to a sequence of operations 200 illustrated in FIG. 2 and carried out e.g. by unit 10 illustrated in FIG. 1. According to an embodiment of the invention, two digital signal portions, coming from the same sensor and corresponding to distinct sampling frequencies, are correlated with each other. In accordance with certain embodiments of the invention, the sensor 12 is designed and operable for sampling a seismic signal at a sampling rate that facilitates collection of the signal of interest at discrete and distinct frequencies. For example, as illustrated in FIG. 2 in a non-limiting manner, the signal is collected at least at a first frequency of interest and at a second frequency of interest distinct from the first frequency (operation 210). The A/D converter 14 converts the collected signal to a digital signal that includes a first digital signal portion corresponding to the signal portion collected at the first frequency, and a second digital signal portion corresponding to the signal portion collected at the second frequency (operation 220). The processor 16 is configured for generating a first and a second intensity distribution in frequency-time domain corresponding to the first and second digital signal portions, respectively (DFT—Discrete Fourier Transform), thereby constituting a first intensity vector u and a second intensity vector v (operation 230). The processor 16 is further configured for calculating a correlation between vectors u, v and for checking if a predetermined correlation rule is met by the vectors u, v. Processor 16 is further configured for indicating a detection of the seismic or acoustic signal of interest when a correlation between vectors u, v is found (operation 240).

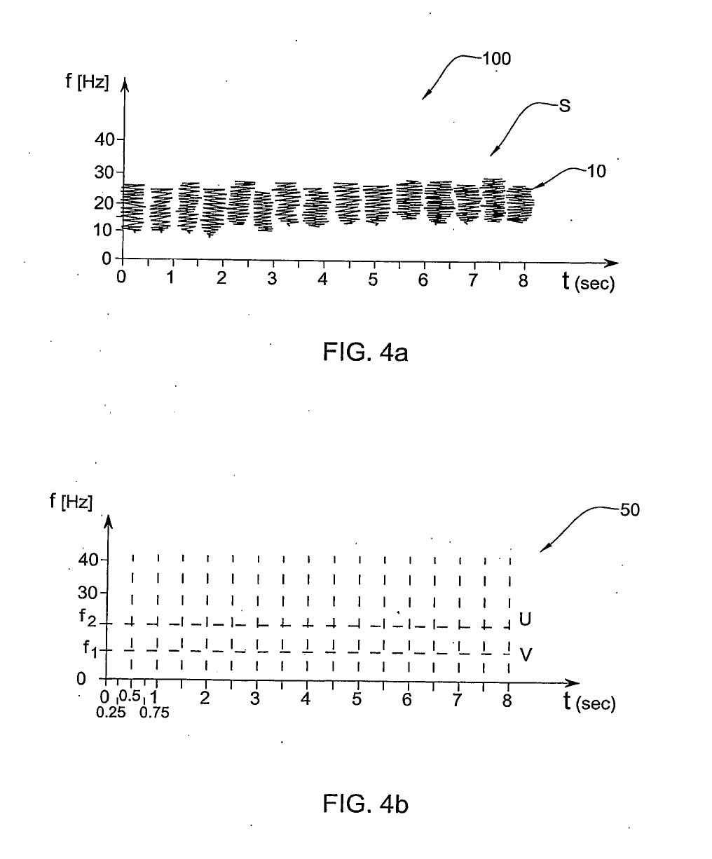

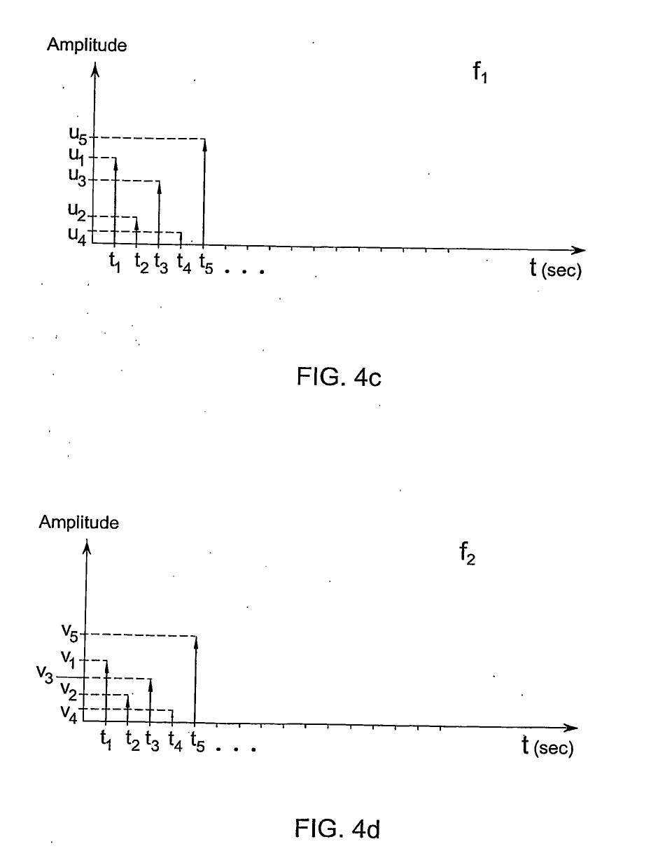

For simplicity, correlation between only two vectors u, v is illustrated in FIG. 2 although the invention is not limited by the number of frequencies (vectors). Three, four and more frequencies could be sampled and analyzed in order to detect correlation. As will be discussed below with reference to FIGS. 4a-4b, according to embodiments of the invention, practical detection results are obtained by analyzing only two frequencies.

For simplicity of explanation, in the above-detailed description, each of the collected frequencies was presented as a single frequency having a discrete value. It should be clear that with respect to each frequency of interest, collection of the corresponding signal portion includes collecting signal portions at a frequency band that includes the frequency of interest.

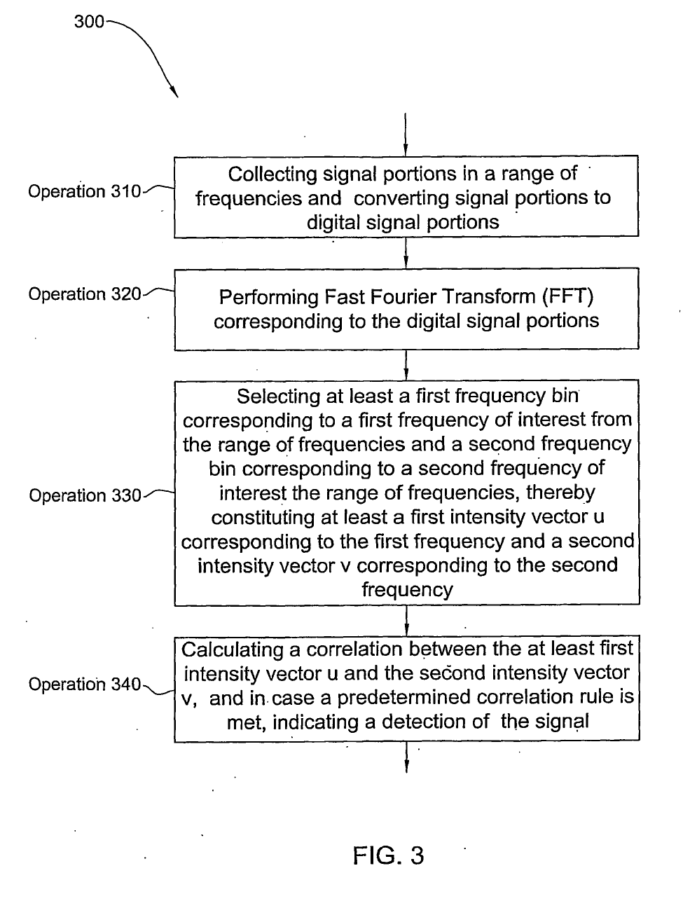

According to another embodiment of the invention illustrated by a sequence of operations 300 shown in FIG. 3, the sensor (e.g. element 12 shown in FIG. 1) is configured for sampling a seismic signal at a sampling rate that facilitates collection of signal portions in a range of frequencies (operation 310). The A/D converter (e.g. element 14 shown in FIG. 1) converts the collected signal to a digital signal (operation 310). The processor 16 is configured for generating an intensity distribution in frequency-time domain corresponding to the digital signal portions, (FFT—Fast Fourier Transform) (operation 320). The processor 16 is further configured for selecting at least a first frequency bin corresponding to a first frequency of interest from the range of frequencies, and a second frequency bin corresponding to a second frequency of interest from the range of frequencies, thereby constituting at least a first intensity vector u corresponding to the first frequency and a second intensity vector v corresponding to the second frequency (operation 330). The processor 16 is further configured for calculating a correlation between vectors u, v and for checking if a predetermined correlation rule is met by the vectors u, v. Processor 16 is further configured for indicating a detection of the signal of interest when a correlation between vectors u, v is found (operation 340).

For simplicity, correlation between only two vectors u, v is illustrated in FIG. 3 however the invention is not limited by the number of frequencies (vectors). Three, four and more frequencies could be selected and analyzed in order to detect correlation. As will be discussed below with reference to FIGS. 4a-4b, according to embodiments of the invention, practical detection results are obtained even by analyzing only two frequencies.

Practically, UGS devices are designed for various applications, including vehicle detection and pedestrian detection. According to the embodiment of the invention illustrated in FIG. 3, the full FFT spectrum (corresponding to e.g. 0-30 Hz range—typically suitable for pedestrian detection), is collected. According to another embodiment of the invention, the 0-100 Hz frequency range—typically suitable for vehicle detection, is made available, e.g. by the same sensor responsible for collecting vehicle-generated signals. According to this embodiment, output available for vehicle detection is also used for pedestrian detection. This increases efficiency and power consumption. In addition, according to embodiments of the invention, pedestrian detection analysis of the full FFT spectrum (or major parts thereof) is replaced by a more efficient and power-saving processing of data relating to minor parts of the available FFT spectrum, e.g. as detailed above with reference to FIG. 3.

According to certain embodiments, the present invention provides efficient, low complexity (and low clock rate), credible detection methods and detection devices for detection of non-stationary signals. This will now be explained with reference to FIGS. 4a-4d.

FIGS. 4a-4d are graphical representations illustrating e.g. operations 200 (illustrated in FIG. 2) or operations 300 (illustrated in FIG. 3) carried out e.g. by the apparatus 10 according to the embodiment of the invention illustrated in FIG. 1. FIG. 4a schematically illustrates a representation 400 of a non-stationary seismic signal caused e.g. by a pedestrian in the frequency-time domain. In FIG. 4a, the signal S is formed as a sequence of distinct spikes 410, all substantially in the 10-30 Hz range, each spike corresponding to a pedestrian's step (for example at t=0.25 sec, 0.75 sec, . . . ). Intermissions between the spikes correspond to intermissions between steps (for example at t=0.5 sec, 1 sec, . . . ). For simplicity of illustration, only spikes are presented in FIG. 4a, however in reality, the frequency-time domain representation includes values corresponding to e.g. background, noise and signals not of interest. Furthermore, in order to assist explanations, the amplitude (energy) of the signal is not presented in FIG. 4a. Additionally, FIG. 4a illustrates spikes corresponding to a single pedestrian walking at a constant pace. It should be clear that the invention is not limited to the illustrated simplified situation.

FIG. 4b schematically illustrates the same signal illustrated in FIG. 4a, represented at two distinct frequencies 4 and f₂ (e.g. 13 Hz and 20 Hz, respectively). The amplitude representation corresponding to the signal portion collected at frequency f₁ is marked as vector v, and the amplitude representation corresponding to the signal portion collected at frequency f₂ is marked as vector u. In the non-limiting example of FIGS. 4a-4d, intensity vector v corresponding to f₁ has 32 components (corresponding to readings every 0.25 sec. for 8 seconds) and, by marking high intensity values as 1 and low intensity values as 0, vector v is written as: (1,0,1,0, . . . ). The same applies to vector u. Put differently, each of the intensity vectors is the outcome of DFT processing—e.g. in the case of the embodiment illustrated in FIG. 2; or a FFT bin (or part thereof)—e.g. in the embodiment of the invention illustrated in FIG. 3.

As is clearly illustrated in FIG. 4b, vector v correlates with vector u. When no physical phenomenon with ordered form occurs, no correlation between vectors u, v is expected. Thus, according to an embodiment of the present invention, the measure of correlation between the vectors u and v is used as an indication of the occurrence of a non-stationary signal S having a substantially ordered form.

For simplicity, the amplitude (typically illustrated as the third dimension in the frequency-time domain) of the signal 410 is not illustrated in FIGS. 4a-4b. The amplitude of the vectors u, v is illustrated in a self-explanatory manner in FIGS. 4c-4d. It should be noted that while the vectors u,v correlate with one another, the amplitude values (e.g. vᵢ, u₁, . . . ) need not be identical.

According to an embodiment of the invention, the correlation function C(u,v) of vectors u and v, sometimes called ‘the normalized scalar product’ or ‘the normal’ of u and v is defined as follows:

C(u,v)=<u,v>/(∥u∥*∥v∥) (1)

where u, v denote the two intensity vectors; <u,v> denotes their inner product; Hull, ∥v∥ denote norms of these intensity vectors.

Here too, for simplicity, analysis of two frequencies and correlation between only two vectors u, v is illustrated in FIG. 4b, however the invention is not limited by the number of frequencies (vectors). Three, four and more frequencies could be analyzed in order to detect correlation.

Thus, according to an embodiment of the invention, the correlation analysis between the intensity vectors is performed based on the following correlation function (2):

C^{k}_{i,j}=A<uᵢ,uⱼ>/(∥uᵢ∥*∥uⱼ∥) (2)

where uᵢ, uⱼ denotes any two intensity vectors from among a plurality of k intensity vectors uᵢ, . . . , uₖ; C_{i,j} is the calculated correlation between intensity vectors uᵢ, uⱼ; <uᵢ,uⱼ> denotes an inner product of these two intensity vectors; ∥uᵢ∥, ∥uⱼ∥ denote norms of these intensity vectors; A is a predetermined coefficient; k is an integer equal to or greater than 2; and i, j are integers from 1 and k.

According to an embodiment of the invention, in the case where a full frequency-time representation of the digital signal is available (following FFT), the intensity vectors u₁, . . . uₖ are selected in a manner that ensures that there is an intermediate frequency between fᵢ, the frequency with which uᵢ is associated, and fᵢ₊₁, the frequency with which uᵢ₊₁ is associated. According to an embodiment of the invention, i, j are selected such that binᵢ is not adjacent to bin_{d} (e.g. i, j are both even or both odd). This is done in order to avoid false correlation due to random noise and/or background. According to an embodiment of the invention, coefficient A appearing in equation (2) is replaced with a not constant coefficient Aᵢⱼ, that depends upon the frequencies (bins) which are correlated. This enables to give different weight to different frequencies.

In the above description, the so-called “normalized inner product” is used as the correlation function. It should be clear that the invention is not limited by the type of correlation function that is used and many other correlation functions can be used for assessing the correlation between the intensity vectors without departing from the scope of the invention.

It is assumed that the signal of interest has an ordered form and as a result, correlation between the amplitudes of different frequencies in the received signal indicates occurrence of this ordered form. Put differently, indication of similarity in a signal detected at distinct frequencies at substantially the same time is an indication of a signal having an ordered form. Various techniques could also be used for assessing the similarity between signal amplitudes received substantially at the same time at different frequencies as an indication, of occurrence of a signal having ordered form, without departing from the scope of the present invention.

The so detected ordered form need not necessarily be repetitive or periodic. It should be non-random and persistent—to last for a sufficient time in a certain frequency range in order to be detected. If the analyzed frequencies (intensity vectors) are too close to each other, a certain degree of correlation could be randomly received even for non-ordered signals. If the analyzed frequencies (intensity vectors) are too far from each other, there is a risk that certain ordered signals may not be detected, since the detected amplitude (intensity) varies with frequency (lower amplitudes are detected at higher frequencies) and with range. The selection of frequencies of interest depends on the particularities of specific applications and can be performed in advance, in accordance with field experience.

According to an embodiment of the invention, occurrence of the signal of interest is detected in the sensed signal in case a predetermined correlation rule is met by at least two intensity vectors. According to an embodiment of the invention, correlation rule is met in case a calculated value of said correlation function falls above a predetermined threshold value or below a predetermined threshold value. Turning back to the non-limiting example illustrated in FIGS. 4a-4d, where each of the vectors u, v is indicative of an 8 second digital signal (i.e. having a length L of 8 seconds), calculating the correlation between vectors u, v yields a measure of correlation between the signal of interest at frequency f₁ and at frequency f₂ during 8 seconds.

According to an embodiment of the invention, the length L has an arbitrary value. According to another embodiment of the invention, the length L is predetermined in accordance with characteristics of the physical phenomena that are detected. The length of the intensity vector needs to be long enough to encompass a sufficient portion of the ordered form of the signal of interest. The length of the intensity vector must not be too long, otherwise environmental noise might decrease the calculated correlation (e.g. when steps are captured during a part of a frame). In one example of pedestrian detection, duration of a few steps (e.g. 10 steps) or duration of a few seconds (non-limiting values are 5 seconds, 8 seconds, 10 seconds, 15 seconds, 20 seconds and more) can yield good practical results. The value of L also depends on the characteristics of the sensor and other operational considerations. According to an embodiment of the invention, the value of L is determined in tests and simulations.

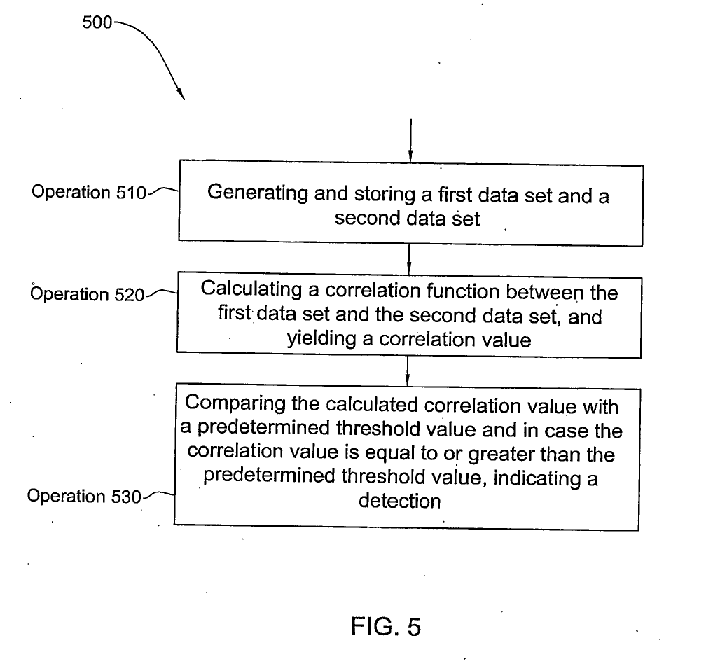

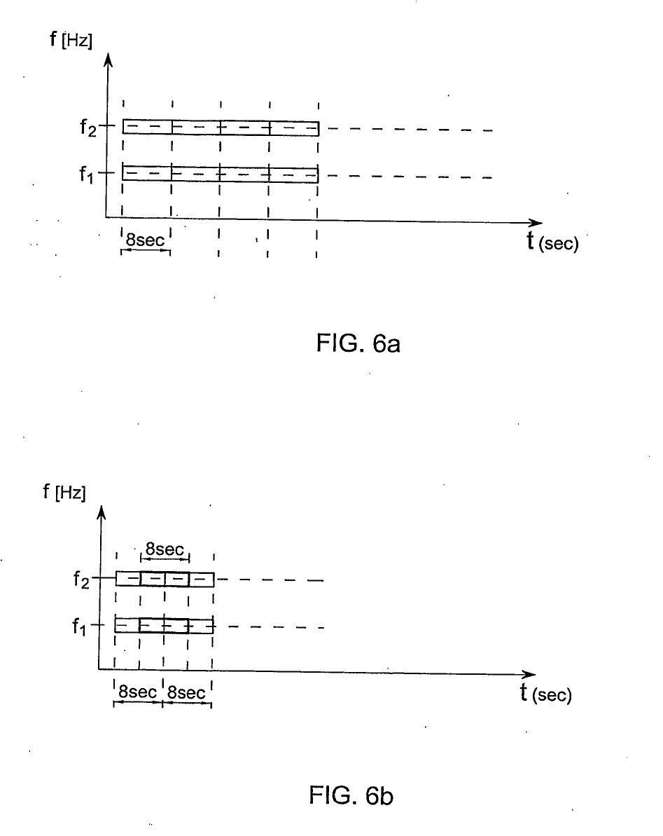

According to certain embodiments of the invention, correlation calculation is performed in a frame-like manner. According to embodiments of the invention, the digital signal is processed as a sequence of intensity vector's frames (sliding windows), each having a length L. The correlation function is calculated per frame (window), and a sequence of correlation values is received. Determination whether the correlation rule is met, is carried out with respect to some or all of the calculated correlation values, according to a predetermined mathematical relation (e.g. majority, average, weighted average, and more). This is illustrated in FIGS. 5, 6a and 6b.

Thus, according to an embodiment of the invention, the sequence of operation 500 illustrated in FIG. 5 is performed:

In operation 510 a first data set and a second data set are generated and stored. The data sets correspond to frames (windows) of the intensity vectors (e.g. u, v illustrated in FIG. 4b). According to an embodiment of the invention, the full frequency range is sampled and FFT is performed e.g. for additional analysis tasks carried out by the same UGS device. The data sets are generated based on extracts of data taken from pre-selected frequency bins, e.g. the ones corresponding to 13 Hz and 20 Hz. According to an embodiment of the invention, a predefined memory buffer is designated for each data set, e.g. two 8 second buffers.

Operation 520 involves calculating a correlation function between the first data set and the second data set so as to yield a correlation value. The outcome of this operation is a scalar representation (theoretically between −1 and 1) of the measure of correlation between the signal collected at the first frequency (e.g. 13 Hz) and the signal collected at the second frequency (e.g. 20 Hz) during a certain 8 second time frame.

Operation 530 involves comparing the calculated correlation value with a predetermined threshold value (e.g. 0.7) and in case the correlation value is equal to or greater than the predetermined threshold value, indicating a detection.

According to an embodiment of the invention, operations 510-530 are performed repeatedly. Thus, the measure of correlation between the signal collected at the first frequency and the signal collected at the second frequency is checked based on successive and substantially disjoint portions of the collected signal (non-overlapping frames—this is illustrated in FIG. 6a). It should be clear that the invention is not limited to the specific example illustrated in FIG. 5 and other manners of operation are possible. For example, according to another embodiment of the invention, correlation between the sampled signals is assessed based on successive and overlapping portions of the digital signal. This is manifested e.g. by generating a succession of data sets (frames), each corresponding to a different frequency-time frame, somewhat overlapping, e.g. overlap of 1, 2, . . . 7 seconds in an 8 second frame (a non-limiting example of 4 seconds overlap is illustrated in FIG. 6b). In the example of FIG. 6b, more calculations are made over the same time, as the information relating to a certain time point is considered in more than one calculation.

Thus, frame-like processing (e.g. as illustrated in FIGS. 6a and 6b) gives rise to a sequence of calculated values of the correlation function. According to an embodiment of the invention, the correlation rule is checked with respect to a plurality of values from among the sequence of calculated values of the correlation function. According to an embodiment of the invention, the correlation rule is met in case a plurality of calculated values from among said sequence of calculated values falls above a predetermined threshold value or below a predetermined threshold value for a predetermined duration of time t. According to an embodiment of the invention, the plurality of calculated values includes successively calculated values.

According to an embodiment of the invention, the duration t has an arbitrary value. According to an embodiment of the invention, both t and L (frame width) are predetermined in accordance with characteristics of the physical phenomena that are detected. According to an embodiment of the invention, e.g. when overlapping windows are used, the length L (frame width) is arbitrary, and the duration t corresponds to characteristics of the physical phenomena that are detected (for example, when 8 seconds frames are checked with 7 seconds overlap between successive frames, a succession of x frames corresponds to an x+8 second portion of the digital signal. Thus, in one example of pedestrian detection, arbitrary length L (e.g. a few seconds or more) and duration t of a few steps (e.g. 10 steps) or a duration t of a few seconds (non-limiting values are 5 seconds, 8 seconds, 10 seconds, 15 seconds, 20 seconds and more) can yield good practical results. The value of t also depends on the characteristics of the sensor and other operational considerations. According to an embodiment of the invention, the values of both L and t are determined in tests and simulations.

According to embodiments of the present invention, practical detection results are obtained by analyzing correlation between intensity vectors corresponding to only a small number of frequencies, e.g. two, three and four frequencies. The complexity of computation involved in analysis of correlation between two vectors (or any other relatively low number of vectors, such as three, four) is reduced when compared to complexity of computation required in accordance with known pedestrian detection methods. This provides for lower clock rate and lower power consumption compared with conventional approaches. This in turn, allows for more efficient operation, lower power consumption, miniaturization of components and reduced hardware demands.

The range from which the signal is collected affects the energy (amplitude) of the collected signal and it is clear that for lower intensities, it is more difficult to distinguish between the signal of interest and the background. The distance between the sensor and the object causing the signal (e.g. a pedestrian) may vary in time (e.g. when the pedestrian is walking in a straight line in the vicinity of the sensor), and thus amplitude of the signal may likewise vary in time. As known in the field of pedestrian detection, presence of e.g. a tree, or a bump between a sensor and a pedestrian, may reduce the amplitude of the signal that is caused by the pedestrian, thus making detection more difficult. Typically, in order to provide credible detection, sophisticated (and expensive) sensors and/or powerful digital signal processing are required. However, as power consumption is proportional to the processor's clock rate, higher complexity calculations increase power dissipation and this poses an undesired operational limitation for applications having limited power sources.

According to embodiments of the present invention, detection of occurrence of a signal of interest is achieved by efficiently distinguishing between the signal of interest and other signals (e.g. background), by cross-correlating information relating to the same physical phenomena as received by the same sensor at least at two different frequencies. As illustrated in FIGS. 4a-4b, intensity vectors corresponding to frequencies of interest include high values, e.g. pulses corresponding to steps, and lower values, corresponding to intermissions between the steps, caused by environmental noise. As is known in the field of pedestrian detection, amplitude differences between the high values and the low values are not always easy to detect, specifically in the range of low frequencies. In the case where no steps occur, high values and low values (caused by environmental noise) are randomly received. According to certain embodiments of the invention, the correlation between the intensity vectors of distinct frequencies is computable, even where there are relatively small amplitude differences between high values and low values. The correlation-based analysis allows for consideration of substantially all received values, including those of relatively small amplitude differences. This is possible because the sequence of operations according to embodiments of the invention (e.g. as illustrated in FIGS. 2, 3 and 5) has no dependency on the energy (amplitude) parameter. There is no amplitude threshold value that singles out a certain range of values for processing. All amplitude values are considered. When there is correlation between values received substantially at the same time at distinct frequencies, this means that the received values correspond to an orderly form such as spikes (steps). Thus, weak and even very weak signals are considered. This in turn, gives rise to increased range, reduced False Alarm Rate (FAR) and increased Probability of Detection (PD). Amplitude variations—between the values received at the distinct frequencies or between values received over time do not interfere with the ability to cross-correlate between the sampled signals.

According to the ‘autonomous UGS’ embodiment of the invention described above e.g. with reference to FIGS. 1, 2, 3 and 5, all computational operations are locally performed. It should be understood that the invention is not limited thereto and other schemes of operation allocation are possible within the scope of the present invention. For example, according to certain embodiments of the invention and in order to satisfy certain operational needs, certain operations are allocated to a remote unit. According to one embodiment of the invention, particularly suitable to network operation mode, the operation of defining detection is allocated to a remote station receiving inputs from several neighboring UGSs. According to another embodiment of the invention, where power considerations are less stressing, the UGS transmits signals indicative of the detected signal to a remote unit and all calculations are performed remotely from the sensor. According to yet another embodiment of the invention, all calculations are performed off-line.

Thus, according to various embodiment of the invention, there is provided one or more of the following: a computerized method for analyzing a signal, e.g. a seismic signal, a computer module configured to perform a computerized method, a computer system which includes such a computer module, a computer program comprising computer program code means for performing a computerized method when said program is run on a computer, a computer program embodied on a computer readable medium, a program storage device readable by a machine for executing a computerized method, and/or a computer program product having computer readable code for executing a computerized method,

A computer module 700 according to an embodiment of the invention is illustrated in FIG. 7, and comprises the following inter-related components: an input component 710, configured for receiving digital signal indicative of the sensed signal, and for constituting at least two from among two or more intensity vectors, each intensity vector being an amplitude representation of the digital signal in the time domain, and wherein each intensity vector is associated with a distinct frequency, belonging to a range of frequencies f; a calculation component 720, configured for calculating a correlation function between the intensity vectors; and an indication component 730 for indicating a detection of the signal of interest in case a predetermined correlation rule is met.

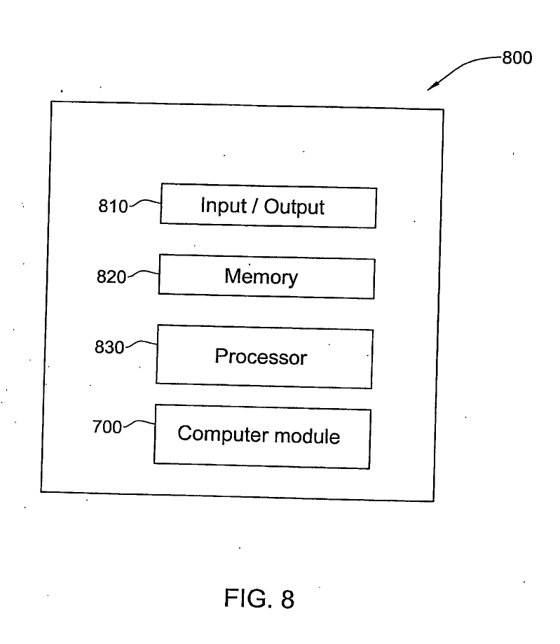

Computer module 700 may be made up of any combination of software, hardware and/or firmware configured to perform the functions defined and described herein. In some embodiments, computer module 700 is a computer program. Such a program may be executed on one or more suitably programmable computers. For example, in one of these embodiments such a program may be executed on a single computer (e.g. computer system 800 illustrated in FIG. 8). According to another of these embodiments, certain operations are allocated to different computers (processing units) wherein output of a certain operation carried out by one computer is communicated to another computer as an input to a respective operation carried out by the other computer.

A computer system 800 according to an embodiment of the invention is illustrated in FIG. 8. The computer system 800 is configured for analyzing a sensed signal in order to detect at least one object causing a signal of interest, and comprises an input/output utility 810 (e.g. a hardware utility, software utility or a hardware/software utility), a memory 820, a processor 830, and computer module 700. In one embodiment where computer module 700 includes a computer program, processor 830 may be coupled to memory 820 and adapted for executing the computer program which is stored on the memory.

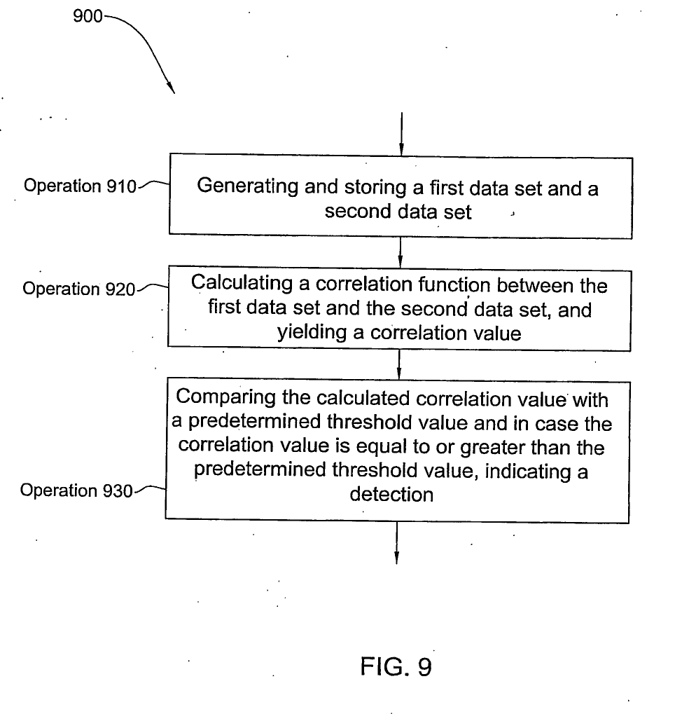

A computerized method 900 according to an embodiment of the invention for analyzing a sensed seismic or acoustic signal in order to detect at least one object causing a signal of interest having an ordered form, is illustrated in FIG. 9. Operation 910 involves calculating a correlation function between at least two from among two or more intensity vectors, each being a time representation of a digital signal corresponding to the sensed signal, and wherein each intensity vector is associated with a distinct frequency belonging to a range of frequencies f.

Operation 920 determines whether a predetermined correlation rule is met by the correlation, indicating a detection of the signal of interest.

It should be understood that the performance of the method according to any of the embodiments of the present invention does not necessarily end upon detection of the presence of the signal of interest. According to certain embodiments of the invention, all operations are substantially continuously performed from the start of an operation as long as new portions of signals or new digital representations (as the case may be) are incoming, or until power shutdown (e.g. when the detection apparatus is autonomously powered). According to another embodiment of the invention, other end events (not illustrated in any of FIGS. 2, 3, 5 and 9) are determined. It should be understood that the invention is not limited by the type and design of either the start event or end event.

In the above description, the practical problem of detecting, under limited power constraints, the presence of an object e.g. a pedestrian characterized by orderly seismic behavior in a range of relatively low frequencies of about 0-30 Hz is addressed, and the concepts of the present invention have been presented with respect to this practical problem. As described above, the present invention is suitable for the detection of seismic signals having an ordered form in the frequency-time domain (e.g. continuous, repetitive, periodic, etc.), and thus is suitable to solve the above-mentioned practical problem. It should be understood that the invention is not limited to the above practical problem and its typical constraints, and can be useful for other detection tasks. Furthermore, the concepts of the present invention can be implemented under various operational and practical constraints, and are advantageous also to cases where power constraints are not as stressing as in UGSs.

It therefore should be clear that the invention is not limited by the range of frequencies and can be applied to suitable frequency range. Moreover, the invention is not limited to the detection of pedestrians and can be used to detect any object that produces a non stationary signal having an ordered form, existing in a certain frequency range and lasting for a certain duration of time. Human and animal steps, as well as hammer knockings on metal pipes, are non-limiting examples of physical phenomena that cause such a signal. It should be clear that the invention is not limited by the type and kind of physical phenomena causing such a signal.

It is to be understood that the invention is not limited in its application to the details set forth in the description contained herein or illustrated in the drawings. The invention is capable of other embodiments and of being practiced and carried out in various ways. It should be noted that the invention is not bound by the specific algorithm of processing or specific structure. Those versed in the art will readily appreciate that the invention is, likewise, applicable to any other processing or presentation with equivalent and/or modified functionality which may be consolidated or divided in another manner.

Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present invention.

It will also be understood that the invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A method for detecting at least one object causing a persistent non-random pressure wave, the method comprising:
(i) providing a digital signal representation of said pressure wave that includes respective amplitudes of said signal, in at least two different frequencies; and
(ii) providing a detection indication based on a measured similarity between said respective amplitudes over time.

2. A method according to claim 1 wherein said providing a detection indication includes associating each frequency with an intensity vector corresponding to amplitude values collected at said frequency during a time window L, and said similarity is measured by calculating a correlation function between intensity vectors associated with different frequencies during said time window L.

3. A method according to claim 2 wherein said associating and said calculating are performed as many time as required with respect to different time windows.

4. A method according to any one of claims 1 to 3 wherein said providing a detection indication further includes checking if a predetermined correlation rule is met by said correlation function at least during a predefined duration of time t.

5. A method according to any one of claims 1 to 4 wherein said providing a digital signal representation further comprises sampling a seismic or acoustic signal at a sampling rate that facilitates collecting said two or more different frequencies, and converting sampled signal to digital format.

6. A method according to any one of claims 1 to 4 wherein said providing a digital signal representation further comprises sampling a seismic or acoustic signal at a sampling rate that facilitates collecting a range of frequencies f, and converting sampled signal to digital format.

7. A method according to claim 5 or 6 wherein said range of frequencies f is 0-30 Hz range or 0-100 Hz range.

8. A method according to claim 4 wherein said predetermined correlation rule is met in case a mathematical relation of said correlation function is fulfilled for a predetermined duration of time t.

9. A method according to claim 8 wherein the duration of said time window L and/or said time t is selected from a group of parameters consisting of: a duration of 10 steps of a pedestrian; 3 seconds; 5 seconds; 8 seconds; 10 seconds; 15 seconds; 20 seconds.

10. A method according to claim 3 wherein said different time windows are successive and substantially non-overlapping, giving rise to a sequence of calculated values of said correlation function.

11. A method according to claim 3 wherein said different time windows are successive and overlapping, giving rise to a sequence of calculated values of said correlation function.

12. A method according to claim 5 wherein said digital signal representation is generated by performing Discrete Fourier Transform (DFT) with respect to each of said distinct frequencies.

13. A method according to claim 6 wherein said digital signal representation is generated by performing Fast Fourier Transform (FFT) corresponding to said range of frequencies f and selecting two or more frequency bins corresponding to said different frequencies.

14. A method according to claim 13 wherein said different frequencies are separated by an intermediate frequency range.

15. A method according to claim 13 wherein said two or more frequency bins are separated by at least one intermediate frequency bin.

16. A method according to any one of claims 1 to 13 wherein k frequencies from said range of frequencies f are respectively associated with k intensity vectors U₁, . . . , Uₖ, and wherein said calculating a correlation function is performed in accordance with the correlation function
C^{k}_{i,j}=A_{i,j}<Uᵢ,Uⱼ>/(∥Uᵢ∥*∥Uⱼ∥)
where Uᵢ, Uⱼ denotes any two intensity vectors from among a plurality of k intensity vectors U₁, . . . , Uₖ; C^{k}_{i,j} is a calculated correlation between intensity vectors Uᵢ, Uⱼ; <Uᵢ,Uⱼ> denotes an inner product of these two intensity vectors; ∥Uᵢ∥, ∥Uⱼ∥ denote norms of these intensity vectors; Aij is a predetermined coefficient; k is an integer equal to or greater than 2; and i, j are integers between 1 and k.

17. A computerized method for analyzing a sensed signal in order to detect at least one object causing a persistent non-random signal of interest in a range of frequencies f, the method comprising:
(i) calculating a correlation function between at least two from among two or more intensity vectors, wherein each intensity vector is an amplitude representation in a certain time window of L seconds, of a digital signal indicative of the sensed signal at a distinct frequency belonging to said range of frequencies f, and
(ii) repeating said calculating with respect to different time windows and in case a predetermined correlation rule is met by said correlation function at least during a predefined duration of time t, indicating a detection of said object.

18. A method according to claim 17 wherein said range of frequencies fis 0-30 Hz range or 0-100 Hz range.

19. A method according to claim 17 wherein L and/or t is selected from a group of parameters consisting of: a duration of 10 steps of a pedestrian; 3 seconds; 5 seconds; 10 seconds; 15 seconds; 20 seconds.

20. A method according to any one of claims 17 to 19 wherein said predetermined correlation rule is met in case a mathematical relation of said correlation function is fulfilled for a predetermined duration of time t.

21. A method according to any one of claims 17 to 20 wherein said calculating is carried out successively based on successive and substantially disjoint portions of said digital signal.

22. A method according to any one of claims 17 to 20 wherein said calculating is carried out successively based on successive and overlapping portions of said digital signal.

23. A method according to any one of claims 17 to 22 further comprising sampling said seismic or acoustic signal in said range of frequencies fat a sampling rate that facilitates collecting two or more distinct frequencies of interest, and converting the sensed signal to digital format.

24. A method according to any one of claims 17 to 22 further comprising sampling said seismic or acoustic signal at a sampling rate that facilitates collecting said range of frequencies f, and converting the sensed signal to digital format.

25. A method according to any one of claims 17 to 24 wherein said representation is generated by performing Discrete Fourier Transform (DFT) with respect to each of said distinct frequencies.

26. A method according to any one of claims 17 to 24 wherein said representation is generated by performing Fast Fourier Transform (FFT) corresponding to said seismic or acoustic signal and selecting two or more frequency bins corresponding to said distinct frequencies.

27. A method according to claim 26 wherein said two or more distinct frequencies are separated by an intermediate frequency range.

28. A method according to claim 27 wherein said intermediate frequency range has a width that corresponds to at least one frequency bin.

29. A method according to any one of claims 17 to 28 wherein k intensity vectors U₁, . . . , Uₖ are generated, and wherein said calculating a correlation is performed based on a correlation function
Aᵢⱼ<uᵢ,uⱼ>/(∥uᵢ∥*∥uⱼ∥)
where <uᵢ,uⱼ> denotes an inner product of two from among said k intensity vectors u₁, . . . , uₖ and ∥uᵢ∥, ∥uⱼ∥ denote norms of said intensity vectors, and wherein Aᵢⱼ is a predetermined coefficient, k is an integer equal to or greater than 2 and i,j are integers between 1 to k.

30. A detection device for detecting at least one object causing a signal of interest, the device comprising a sensor for collecting a sensed signal; an A/D converter for converting the sensed signal to digital signal; a memory, a processor, and a computer module, said computer module comprising:
an input component for receiving digital signal indicative of the sensed signal, and for constituting at least two intensity vectors, wherein each intensity vector being an amplitude representation of the digital signal in a time domain, and wherein each intensity vector is associated with a distinct frequency falling in a range of frequencies f, and having a length of L seconds;
a calculation component for calculating a correlation function between said at least two intensity vectors, and
an indication component for indicating a detection of said signal of interest in case a predetermined correlation rule is met by said correlation function at least during a predefined duration of time t.

31. A detection device according to claim 30 wherein said sensor is a seismic sensor or an acoustic sensor.

32. A detection device according to claim 30 or 31 wherein said range of frequencies f is 0-30 Hz range or 0-100 Hz range.

33. A detection device according to any of claims 30 to 32 wherein t or L is selected from a group of parameters consisting of a duration of 10 steps of a pedestrian; 3 seconds; 5 seconds; 10 seconds; 15 seconds; 20 seconds.

34. A detection device according to any one of claims 30 to 33 wherein said processor, A/D converter and memory are implemented on a single electronic module.

35. A detection device according to any one of claims 30 to 34 further comprising a communication unit coupled to and operable by the processor for notifying a remote unit in case of detection.

36. A detection device according to any one of claims 30 to 35 further comprising an autonomous power source.

37. A detection device according to any one of claims 30 to 36 being an Unattended Ground Sensor (UGS) device.

38. A detection device according to any one of claims 30 to 37 wherein said sensor is configured for sampling said signal in said range of frequencies f at a sampling rate that facilitates collecting two or more distinct frequencies of interest.

39. A detection device according to any one of claims 30 to 37 wherein said sensor is configured for sampling said signal at a sampling rate that facilitates collecting said range of frequencies f.

40. A computer system for analyzing a sensed signal in order to detect at least one object causing a signal of interest, the system comprising an input/output utility, a memory, a processor, and a computer module, said computer module comprising:
an input component for receiving via said input/output utility, digital signal indicative of the sensed signal, and for constituting at least two intensity vectors, wherein each intensity vector being indicative of an amplitude representation of the digital signal in a time domain, and wherein each intensity vector is associated with a distinct frequency falling in a range of frequencies f and having a length of L seconds;
a calculation component for calculating a correlation function between said at least two from among two or more intensity vectors, and
an indication component for indicating via said input/output utility, a detection of said signal of interest in case a predetermined correlation rule is met by said correlation function at least during a predefined duration of time t.

41. A computer system according to claim 40 wherein said predetermined correlation rule is met in case a mathematical relation of said correlation function is fulfilled for a predetermined duration of time t.

42. A computer system according to any one of claims 40 to 41 wherein said calculation component is configured for successively performing said calculating based on successive and disjoint portions of said digital signal.

43. A computer system according to any one of claims 40 to 41 wherein said calculation component is configured for successively performing said calculating based on successive and overlapping portions of said digital signal.

44. A computer system according to any one of claims 40 to 43 wherein said input component is configured for generating said representation by performing Discrete Fourier Transform (DFT) with respect to each of said distinct frequencies.

45. A computer system according to any one of claims 40 to 43 wherein said input component is configured for generating said representation by performing a Fast Fourier Transform (FFT) corresponding to said signal and selecting two or more frequency bins corresponding to said distinct frequencies.

46. A computer system according to claim 45 wherein said input component is configured for selecting said two or more frequency bins such that said distinct frequencies of interest are separated by an intermediate frequency range.

47. A computer module for analyzing a sensed signal in order to detect at least one object causing a signal of interest, the computer module comprising:
an input component for receiving digital signal indicative of the sensed signal, and for constituting at least two from among two or more intensity vectors, wherein each intensity vector being an amplitude representation of the digital signal in a time domain, and wherein each intensity vector is associated with a distinct frequency falling in a range of frequencies f and having a length of L seconds;
a calculation component for calculating a correlation function between said at least two from among two or more intensity vectors, and
an indication component for indicating a detection of said signal of interest in case a predetermined correlation rule is met by said correlation function at least during a predefined duration of time t.

48. A program storage device readable by machine, tangibly embodying a program of instructions executable by the machine to perform a method for analyzing a sensed signal in order to detect at least one object causing a signal of interest, the method comprising:
calculating a correlation function between at least two from among two or more intensity vectors, wherein each intensity vector being an amplitude representation in a time domain of a digital signal corresponding to the sensed signal, and wherein each intensity vector is associated with a distinct frequency belonging to a range of frequencies f and having a length of L seconds; and
in case a predetermined correlation rule is met by said correlation function at least during a predefined duration of time t, indicating a detection of said signal of interest.

49. A computer program product comprising a computer useable medium having computer readable program code embodied therein for analyzing a sensed signal in order to detect at least one object causing a signal of interest, the computer program product comprising:
computer readable program code for causing the computer to calculate a correlation function between at least two from among two or more intensity vectors, wherein each intensity vector being an amplitude representation in a time domain of a digital signal corresponding to the sensed signal, and wherein each intensity vector is associated with a distinct frequency belonging to a range of frequencies f and having a length of L seconds; and
computer readable program code for causing the computer, in case a predetermined correlation rule is met by said correlation function at least during a predefined duration of time t, to indicate a detection of said signal of interest.

50. A method for detecting at least one object causing a seismic or an acoustic signal of interest having an ordered form, the method comprising:
sampling said seismic or acoustic signal at a sampling rate that facilitates collecting a sensed signal in a range of frequencies f and converting the sensed signal to digital signal;
calculating a correlation function between at least two from among two or more intensity vectors, wherein each intensity vector is an amplitude representation in a time domain of the digital signal, and wherein each intensity vector is associated with a distinct frequency belonging to said range of frequencies f and is having a length of L seconds; and
determining whether a predetermined correlation rule is met by said correlation function in order to indicate detection of said object.

51. A computer program comprising computer program code means for performing all the steps of any of claim 1 to 29 or 50 when said program is run on a computer.

52. A computer program as claimed in claim 51 embodied on a computer readable medium.
